(19) United States
(12) Patent Application Publication
(10) Pub. No.: US 2026/0361032 A1
(43) Pub. Date: Nov. 12, 2026

(54) CIRCULAR CONNECTOR

(71) Applicant: Changchun Jetty Automotive Technology Co., Ltd., Changchun, Jilin Province (CN)

(72) Inventor: Chao WANG, Changchun (CN)

(21) Appl. No.: 19/486,888

(22) PCT Filed: May 22, 2024
(86) PCT No.: PCT/CN2024/094666

§ 371 Date: Nov. 21, 2025

(30) Foreign Application Priority Data
May 22, 2023 (CN) 202310571700.5

(51) Int. Cl. H01R 13/639; H01R 13/625; H01R 13/627

(52) U.S. Cl. CPC H01R 13/639; H01R 13/625; H01R 13/6272; H01R 2201/26

(57) ABSTRACT

A circular connector, including a socket assembly and a plug assembly mated with each other, and a cylindrical plastic housing which is sleeved on outer peripheries of the socket assembly and the plug assembly and rotatable relative to both. A side wall of the plastic housing is provided with a U-shaped opening, which includes two side slots arranged opposite each other and a circumferential slot connecting ends of the two side slots. The U-shaped opening surrounds a snap cantilever with a single free end, and the free end of the snap cantilever is provided with a snap groove. In the present disclosure, when the plastic housing is rotated to a predetermined position, the snap groove formed on the snap cantilever engages with the plug snap protrusion, the socket locking protrusion enters the circumferential slot and abuts against a side edge of the circumferential slot to achieve primary locking.

### RELATED APPLICATION

The present disclosure claims priority to Chinese Patent Application No. 202310571700.5 filed on May 22, 2023, which is hereby incorporated by reference in its entirety.

### TECHNICAL FIELD

The present disclosure relates to the technical field of automotive connectors, and particularly to a circular connector.

### BACKGROUND

In the assembly process of new energy vehicles, a large number of connectors are required for the connection between various circuits, among which circular connectors are commonly used. In order to prevent the accidental loosening and falling off of the parts of the connector during use, locking structures need to be designed for the connectors. Currently, the locking structures for circular connectors mainly include spiral type, steel ball locking type, threaded connection type, bolt connection type, etc. However, these existing structures have drawbacks: the spiral structure is complex in structure with too many parts and large overall dimensions; the steel ball locking type has high requirements for a steel ball riveting process and has limitations, mainly being applied to metal connectors; the threaded connection type and the bolt connection type require reserved space for tool mounting, and both mounting and disassembly involve thread tightening/loosening, resulting in a poor mounting experience for customers.

### SUMMARY

The present disclosure provides a circular connector with a compact overall dimension, which is applicable to both metal and plastic materials, and has the advantages of simple operation, stable structure and high reliability.

The present disclosure provides a circular connector, including a socket assembly and a plug assembly mated with each other, and a cylindrical plastic housing which is sleeved on outer peripheries of the socket assembly and the plug assembly and rotatable relative to both. A side wall of the plastic housing is provided with a U-shaped opening, which includes two side slots arranged opposite each other and a circumferential slot connecting ends of the two side slots. An opening or a bridging beam is provided along a direction of one of the side slots between an end of the plastic housing and the circumferential slot. The U-shaped opening surrounds a snap cantilever with a single free end, and the free end of the snap cantilever is provided with a snap groove.

an outer wall of the plug assembly is provided with a plug snap protrusion, and an outer wall of the socket assembly is provided with a socket locking protrusion; the plug snap protrusion and the socket locking protrusion enter the U-shaped opening through the opening or the bridging beam after being aligned along an axial direction of the circular connector; and after the plastic housing is rotated, the plug snap protrusion engages with the snap groove, and the socket locking protrusion enters the circumferential slot and engages with a side edge of the circumferential slot.

In an optional embodiment, an end of the snap cantilever without the snap groove is connected to the plastic housing, and provided with a pressing part capable of driving the free end of the snap cantilever to tilt up.

In an optional embodiment, the end of the snap cantilever without the snap groove is connected to the plastic housing through a connecting rib. A ratio of a linear distance from an end of the pressing part far away from the connecting rib to the connecting rib, to a linear distance from the free end of the snap cantilever to the connecting rib is ⅓ to ⅔.

In an optional embodiment, there is a gap between the pressing part and the outer wall of the plug assembly.

In an optional embodiment, the plug snap protrusion extends radially outward from the plug assembly and tapers in width along its extending direction.

In an optional embodiment, the socket locking protrusion and the plug locking protrusion are spaced apart along the axial direction of the circular connector. When the plastic housing is rotated to a predetermined position, the free end of the locking cantilever is embedded between the socket locking protrusion and the plug locking protrusion.

In an optional embodiment, a limiting groove is provided on an outer wall of the plug assembly along a generatrix direction of the plug assembly. A limiting rib is provided on an inner wall of the plastic housing and protrudes inward to mate with the limiting groove. When the plastic housing is rotated to a predetermined position, the limiting rib abuts against a side wall of the limiting groove.

In an optional embodiment, the circular connector further includes a secondary lock body inserted in the limiting groove, the secondary lock body includes a baffle and at least one first cantilever fixed to the baffle, and a first protrusion is protrudingly provided on an end face of the first cantilever. A cantilever groove for being mated with the first cantilever is formed on the plastic housing along a circumferential direction. When the plastic housing is rotated to a predetermined position, the secondary lock body is capable of being pushed to enable the first protrusion on the first cantilever to engage with the cantilever groove to realize secondary locking.

In an optional embodiment, the secondary lock body further includes a second cantilever fixedly connected to the baffle, with a length longer than that of the first cantilever, and a second protrusion is protrudingly provided on a side of the second cantilever far away from the first cantilever. A pre-mounting groove communicated with the limiting groove is provided on the outer wall of the plug assembly along the circumferential direction. When the secondary lock body is partially inserted into the limiting groove, the second protrusion engages with the pre-mounting groove. When the secondary lock body is fully inserted into the limiting groove, the first protrusion on the first cantilever engages with the cantilever groove.

In an optional embodiment, the baffle, the first cantilever and the second cantilever are integrally injection-molded.

In an optional embodiment, an end of the plastic housing mated with the secondary lock body is recessed inward to form a lock body embedding groove for the baffle to be embedded in.

In an optional embodiment, a retractable third protrusion is further provided on the side of the second cantilever far away from the first cantilever. When the secondary lock body is fully inserted into the limiting groove, the third protrusion engages with the pre-mounting groove.

In an optional embodiment, a retraction groove for the third protrusion to be embedded in is formed on the second cantilever, and a return spring is provided between the third protrusion and the retraction groove. When the third protrusion is pressed by an inner wall of the limiting groove, the third protrusion at least partially retracts into the retraction groove.

In an optional embodiment, a third cantilever is provided in the cantilever groove of the plastic housing, and has one end connected to the plastic housing and the other end extending in a direction opposite to a mounting direction along which the plastic housing is mounted into the plug assembly. The free end of the third cantilever is capable of engaging with a side wall of the pre-mounting groove after the plastic housing is mounted.

The circular connector of the present disclosure features a plastic housing rotatably disposed on the outer sides of the socket assembly and the plug assembly. When the plastic housing is rotated to a predetermined position, the snap groove formed on the snap cantilever engages with the plug snap protrusion, and the socket locking protrusion enters the circumferential slot and abuts against a side edge of the circumferential slot, thereby achieving primary locking. Subsequently, secondary locking is achieved through the secondary lock body provided between the plug assembly and the plastic housing. The circular connector of the present disclosure has no restrictions on the materials of the socket assembly and the plug assembly, and achieves the advantages of compact overall dimension, simple and reliable operations, etc.

### BRIEF DESCRIPTION OF THE DRAWINGS

The drawings, which are incorporated in and constitute a part of the specification, illustrate embodiments of the present disclosure and, together with the description, serve to explain the principles of the present disclosure.

FIG. 1 is a structural schematic diagram of a circular connector according to an embodiment of the present disclosure;

FIG. 2 is a structural schematic diagram of a plastic housing in the circular connector shown in FIG. 1;

FIG. 3 is a structural schematic diagram of the plastic housing in the circular connector shown in FIG. 1 from another perspective;

FIG. 4 is a structural schematic diagram of a plug assembly in the circular connector shown in FIG. 1;

FIG. 5 is a structural schematic diagram of a socket assembly in the circular connector shown in FIG. 1;

FIG. 6 is a structural schematic diagram of a secondary lock body in the circular connector shown in FIG. 1;

FIG. 7 is an assembly schematic diagram of a secondary lock body within a limiting groove; and

FIG. 8 is a structural schematic diagram of a secondary lock body according to another embodiment of the present disclosure.

### REFERENCE NUMERALS

1: socket assembly; 11: first connecting part; 111: socket locking protrusion; 2: plug assembly; 21: second connecting part; 22: plug snap protrusion; 23: first outer ring; 231: first limiting surface; 24: second outer ring; 25: limiting groove; 26: pre-mounting groove; 3: plastic housing; 31: bridging beam; 32: snap cantilever; 321: pressing part; 322: snap groove; 323: connecting rib; 33: lock body embedding groove; 34: cantilever groove; 341: third cantilever; 35: limiting rib; 36: circumferential slot; 37: side slot; 4: secondary lock body; 41: baffle; 42: second cantilever; 421: second protrusion; 422: third protrusion; 423: retraction groove; 424: return spring; 43: first cantilever; 431: first protrusion.

### DETAILED DESCRIPTION OF THE EMBODIMENTS

Various exemplary embodiments of the present disclosure will now be described in detail with reference to the drawings. It should be noted that the relative arrangements, numerical expressions and numerical values of components and steps set forth in these embodiments do not limit the scope of the present disclosure unless otherwise specified.

The following description of at least one exemplary embodiment is merely illustrative in nature and is in no way intended to limit the present disclosure and the applications or uses thereof.

Techniques, methods and devices known to those skilled in the art may not be discussed in detail, but should be regarded as part of the specification under appropriate circumstances.

In all examples illustrated and discussed here, any specific value should be interpreted as illustrative only and not as a limitation. Therefore, other examples of the exemplary embodiments may have different values.

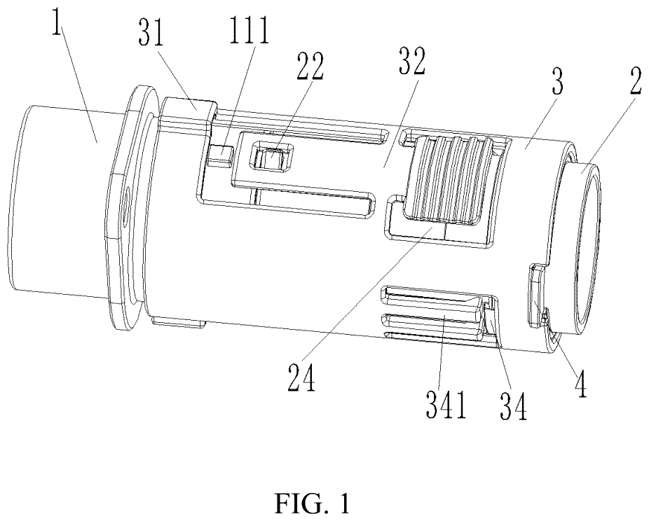

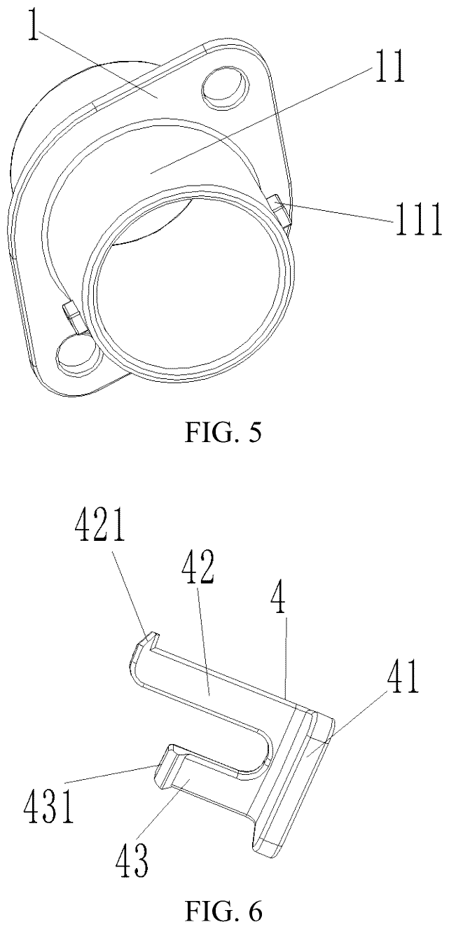

Embodiments of the present disclosure provide a circular connector, as shown in FIGS. 1 to 5, including a socket assembly 1 and a plug assembly 2 mated with each other. An end of the socket assembly 1 is provided with a first connecting part 11. An end of the plug assembly 2 is provided with a second connecting part 21 that can be inserted into the first connecting part 11. An inner wall of the first connecting part 11 and an outer wall of the second connecting part 21 are provided with interlocking keys (not shown in the figures) to prevent relative rotation between them. The arrangement of the interlocking keys allows the first connecting part 11 and the second connecting part 21 to be plugged with each other only at a specific angle and prevents relative rotation therebetween after plugging, thereby improving connection reliability.

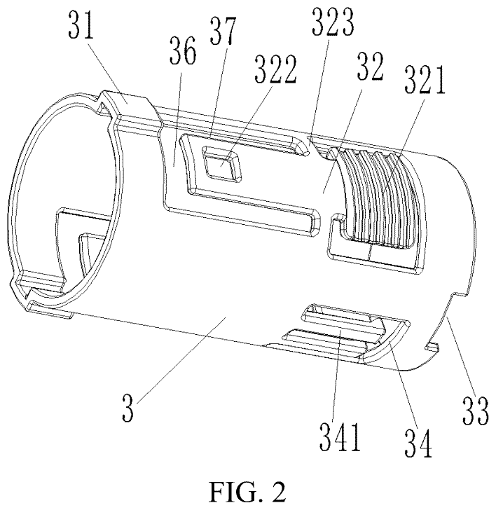

As shown in FIGS. 1 and 2, the circular connector further includes a cylindrical plastic housing 3, which is sleeved on outer peripheries of the socket assembly 1 and the plug assembly 2 and rotatable relative to both. A side wall of the plastic housing 3 is provided with a U-shaped opening, which includes two side slots 37 arranged opposite each other and a circumferential slot 36 connecting ends of the two side slots. An opening or a bridging beam 31 is further provided along a direction of one of the side slots 37 between an end of the plastic housing 3 and the circumferential slot. Here, considering the strength of the plastic housing 3, the bridging beam 31 is preferably selected. An outer wall of the plug assembly 2 is provided with a plug snap protrusion 22, and an outer wall of the socket assembly 1 is provided with a socket locking protrusion 111. A space defined by the bridging beam 31 and the side slot 37 corresponding to the bridging beam 31 together penetrate the plastic housing 3 to form a channel for the plug snap protrusion 22 and the socket locking protrusion 111 to pass through. The U-shaped opening surrounds a snap cantilever 32 with a single free end, and the free end of the snap cantilever 32 is provided with a snap groove 322. After the socket assembly 1 and the plug assembly 2 are assembled, the plug snap protrusion 22 and the socket locking protrusion 111 are aligned along an axial direction of the circular connector, and both enter the U-shaped opening through the opening or the bridging beam 31. After the plastic housing 3 is rotated, the plug snap protrusion 22 engages with the snap groove 322, and the socket locking protrusion 111 enters the circumferential slot 36 and abuts against a side edge of the circumferential slot 36, thereby achieving primary locking. The circular connector of the present disclosure imposes no limitations on the materials of the socket assembly and the plug assembly, and offers advantages such as compact overall size and simple, reliable operation.

In an embodiment, in order to facilitate the plug snap protrusion 22 to smoothly engage with the snap groove 322, an end of the snap cantilever 32 without the snap groove 322 is connected to the plastic housing 3 through a connecting rib 323, and the end is provided with a pressing part 321 capable of driving the free end of the snap cantilever 32 to tilt up. This structure resembles a seesaw. It should be noted that, to ensure the free end of the snap cantilever 32 can tilt up smoothly when the pressing part 321 is pressed, the pressing part 321 should be made relatively thin to maintain a gap between it and the outer wall of the plug assembly 2. Meanwhile, in order to achieve the optimal use effect, a ratio of a linear distance from an end of the pressing part 321 far away from the connecting rib 323 to the connecting rib 323, to a linear distance from the free end of the snap cantilever 32 to the connecting rib 323, should be ⅓ to ⅔, and exemplarily 1:2.

In addition, the plug snap protrusion 22 is located on a rotation path of the snap cantilever 32. When the pressing part 321 is pressed and the plastic housing 3 is rotated to a predetermined position, the snap groove 322 formed on the snap cantilever 32 is engaged with the plug snap protrusion 22, so that the plug snap protrusion 22 can smoothly engage with the snap groove 322, thereby achieving primary locking. Further, the plug snap protrusion 22 extends radially outward from the plug assembly 2 and tapers in width along its extending direction, providing a certain guiding effect to ensure that the plug snap protrusion 22 can smoothly engage with the snap groove 322.

In this embodiment, in order to ensure the stability of the primary locking structure, the snap cantilever 32 and the pressing part 321 are located on the outer side of the plug assembly 2, and an end of the snap cantilever 32 provided with the snap groove 322 extends to the outer side of the socket assembly 1. The socket locking protrusion 111 and the plug snap protrusion 22 are spaced apart along the axial direction of the circular connector. When the plastic housing 3 is rotated to a predetermined position, the end of the snap cantilever 32 provided with the snap groove 322 is embedded between the socket locking protrusion 111 and the plug snap protrusion 22. At this time, the snap cantilever 32 is attached to the outer walls of both the plug assembly 2 and the socket assembly 1, thereby providing a retention force to prevent separation between the plug assembly 2 and the socket assembly 1, as specifically shown in FIG. 1.

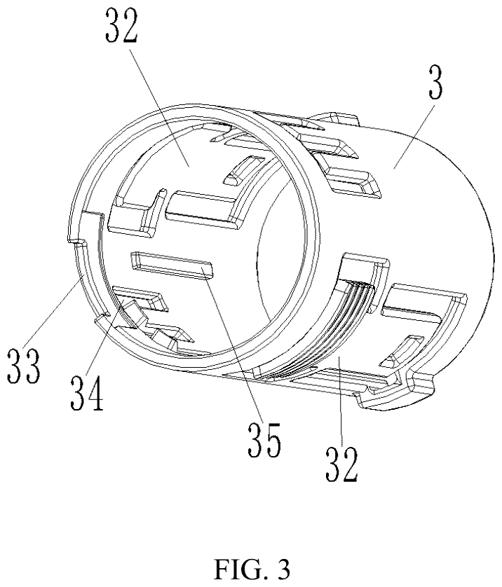

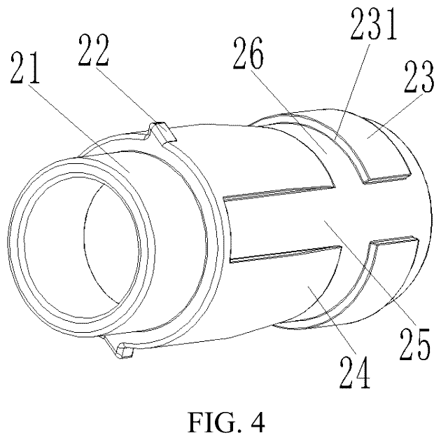

In an embodiment, as illustrated in FIGS. 3 and 4, the outer wall of the plug assembly 2 is provided with a limiting groove 25 along a generatrix direction of the plug assembly 2, and the inner wall of the plastic housing 3 is protrudingly provided with a limiting rib 35 mated with the limiting groove 25. When the plastic housing 3 is rotated to a predetermined position, the limiting rib 35 abuts against a side wall of the limiting groove 25. The limiting rib 35 is located in the limiting groove 25 and has a smaller width than the limiting groove 25, allowing the plastic housing 3 to rotate slightly about the axis of the plug assembly 2. Rotation stops when the opposite side walls of the limiting rib 35 contact with the corresponding inner side walls of the limiting groove 25—these two contact positions define two rotational limit positions. The two rotational limit positions of the limiting rib 35 within the limiting groove 25 are defined as the “mounting position” and the “locking position” of the plastic housing 3, respectively.

During the assembly of the primary lock of the present disclosure, the plug snap protrusion 22 is inserted along the bridging beam 31 and the side slot 37, and when it is inserted in place (here referring to the mounting position of the plastic housing), the socket assembly 1 is mounted into the plastic housing 3 through the socket locking protrusion 111. Subsequently, rotating the plastic housing 3 causes the socket locking protrusion 111 to move from the side slot 37 to the circumferential slot 36, thereby achieving primary locking (here referring to the

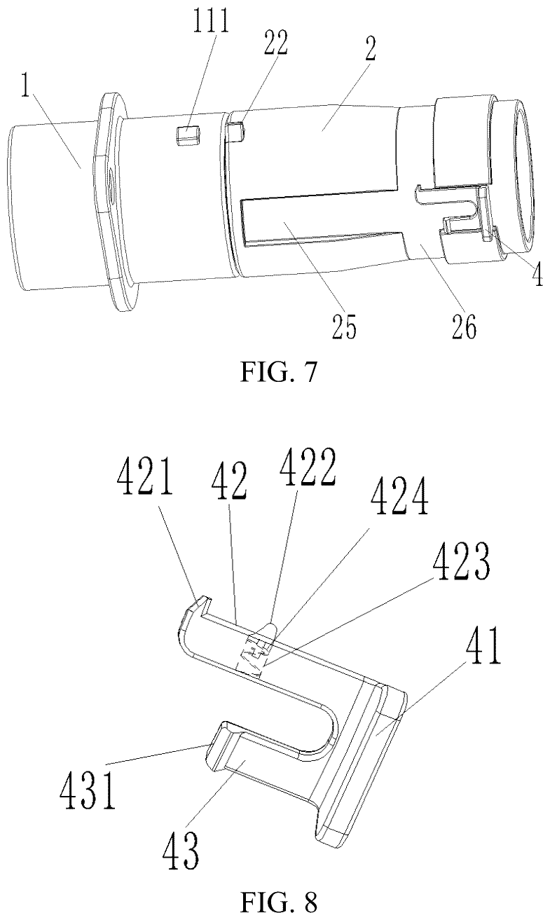

In an embodiment, as illustrated in FIGS. 6 and 7, the circular connector further includes a secondary lock body 4 inserted in the limiting groove 25. The secondary lock body includes a baffle 41 and at least one first cantilever 43 fixedly connected to the baffle 41, with a first protrusion 431 protrudingly provided on an end face of the first cantilever 43. A cantilever groove 34 for being mated with the first cantilever 43 is formed on the plastic housing 3 along a circumferential direction. When the plastic housing 3 is rotated to the predetermined position, the secondary lock body 4 is pushed to enable the first protrusion 431 on the first cantilever 43 to engage with the cantilever groove 34, thereby achieving secondary locking. Further, the secondary lock body 4 further includes a second cantilever 42 fixedly connected to the baffle 41, with a length longer than that of the first cantilever 43, and a second protrusion 421 is protrudingly provided on a side of the second cantilever 42 far away from the first cantilever 43. A pre-mounting groove 26 communicated with the limiting groove 25 is provided on the outer wall of the plug assembly 2 along the circumferential direction. When the secondary lock body 4 is partially inserted into the limiting groove 25, the second protrusion 421 engages with the pre-mounting groove 26 to realize the pre-mounting of the secondary lock body 4. When the secondary lock body 4 is fully inserted into the limiting groove 25, the first protrusion 431 on the first cantilever 43 engages with the cantilever groove 34, thereby achieving secondary locking.

It should be noted here that: (1) if the size of the cantilever groove 34 matches the size of the first protrusion 431 on the first cantilever 43, when the secondary lock body 4 is fully inserted into the limiting groove 25, the first protrusion 431 on the first cantilever 43 engages with the cantilever groove 34, thereby achieving secondary locking and preventing relative rotation between the plastic housing 3 and the secondary lock body 4.

(2) if the size of the cantilever groove 34 is relatively large, the end of the plastic housing 3 mated with the secondary lock body 4 needs to be recessed inward to form a lock body embedding groove 33 for the baffle to be embedded in. When the secondary lock body 4 is fully inserted into the limiting groove 25, the baffle 41 of the secondary lock body 4 is completely embedded into the lock body embedding groove 33, effectively preventing rotation between the plastic housing 3 and the secondary lock body 4 and preventing the secondary lock body 4 from falling off due to accidental contact. Further, the cantilever groove 34 may be provided with a third cantilever 341, which has one end connected to the plastic housing 3 and the other end extending in a direction opposite to a mounting direction along which the plastic housing 3 is mounted into the plug assembly 2. After the plastic housing 3 is mounted, the free end of the third cantilever abuts against a side wall of the pre-mounting groove 26 to prevent the plastic housing 3 from retreating.

In an embodiment, as illustrated in FIG. 8, a retractable third protrusion 422 is further provided on a side of the second cantilever 42 far away from the first cantilever 43. The third protrusion 422 is arranged as follows: a retraction groove 423 for the third protrusion 422 to be embedded in is formed on the second cantilever 42, a return spring 424 is provided between the third protrusion 422 and the retraction groove, and when the third protrusion 422 is pressed by an inner wall of the limiting groove 25, the third protrusion 422 at least partially retracts into the retraction groove 423. In a natural state, the third protrusion 422 protrudes beyond the side wall of the second cantilever 42, and its end is generally flush with the second protrusion 421. When the secondary lock body 4 is fully inserted into the limiting groove 25, the third protrusion 422 engages with the pre-mounting groove 26. At this time, as described above, the first protrusion 431 on the first cantilever 43 engages with the cantilever groove 34. These two protrusions limit the plastic housing 3 in the axial and circumferential directions, respectively. Compared to relying solely on the first protrusion 431 and the side wall of the second cantilever 42, the circumferential limiting effect is better, ensuring the stability of the secondary lock body 4.

When the present disclosure is in use, first align the plug snap protrusion 22 with the bridging beam 31, and mount the plastic housing 3 onto the plug assembly 2. Then align the bridging beam 31 with the socket locking protrusion 111 to mate the socket assembly 1 with the plug assembly 2. During mating, the plug snap protrusion 22 is confined to move within the side slot 37, providing a guiding role. Once fully mated, the socket locking protrusion 111 also enters the side slot 37.

Next is the primary locking process: while pressing down the pressing part 321, rotate the plastic housing 3, causing the socket locking protrusion 111 to move from the side slot 37 into the circumferential slot 36 and rotate in the circumferential slot 36, which provides a guiding role; after the plastic housing 3 is rotated to the predetermined position (i.e., the locking position), release the pressing part 321; at this time, the plug snap protrusion 22 is fixed in the snap groove 322, achieving dual limiting in both circumferential rotation and axial movement. The primary locking can already meet the usage requirements in some application environments.

In some harsh usage environments, a secondary lock may also be mounted: at the locking position of the primary lock, the limiting groove 25 corresponds to the position of the lock body embedding groove 33. When inserting the secondary lock body 4, its first cantilever 43 and second cantilever 42 insert into the limiting groove 25, and its baffle 41 engages with the lock body embedding groove 33, until the first protrusion 431 on the end face of the first cantilever 43 engages with the cantilever groove 34 to produce a “click” sound. It is also observable from the outside that the first protrusion 431 hangs on an edge of the cantilever groove 34—this confirms secondary locking. At this time, the first cantilever 43 limits axial movement, and the first cantilever 43 and second cantilever 42 jointly limit circumferential rotation.

During unlocking, first release the secondary lock: forcefully pull out the secondary lock body 4 or press the first protrusion 431 on the first cantilever 43 to withdraw the secondary lock body 4. Since the first cantilever 43 and the second cantilever 42 have different lengths, once the first cantilever 43 is disengaged from the limiting groove 25, the second protrusion 421 on the second cantilever 42 remains engaged with the side wall of the pre-mounting groove 26, preventing the secondary lock body 4 from falling off.

Next, release the primary lock: press down the pressing part 321 to disengage the plug snap protrusion 22 from the snap groove 322, and then rotate the plastic housing 3 in the reverse direction to complete unlocking.

Although some specific embodiments of the present disclosure have been described in detail by examples, it should be understood by those skilled in the art that the above examples are only for illustration and are not intended to limit the scope of the present disclosure. It should be understood by those skilled in the art that the above embodiments can be modified without departing from the scope and the spirit of the present disclosure. The scope of the present disclosure is defined by the appended claims.

1. A circular connector, comprising a socket assembly and a plug assembly mated with each other, and a cylindrical plastic housing which is sleeved on outer peripheries of the socket assembly and the plug assembly and rotatable relative to both, wherein:
a side wall of the plastic housing is provided with a U-shaped opening, which comprises two side slots arranged opposite each other and a circumferential slot connecting ends of the two side slots;
an opening or a bridging beam is provided along a direction of one of the side slots between an end of the plastic housing and the circumferential slot;
the U-shaped opening surrounds a snap cantilever with a single free end, and the free end of the snap cantilever is provided with a snap groove;
an outer wall of the plug assembly is provided with a plug snap protrusion, and an outer wall of the socket assembly is provided with a socket locking protrusion;
the plug snap protrusion and the socket locking protrusion are capable of entering the U-shaped opening through the opening or the bridging beam after being aligned along an axial direction of the circular connector; and
the plug snap protrusion is capable of engaging with the snap groove and the socket locking protrusion is capable of entering the circumferential slot and abutting against a side edge of the circumferential slot after the plastic housing is rotated.

2. The circular connector according to claim 1, wherein an end of the snap cantilever without the snap groove is connected to the plastic housing and is provided with a pressing part capable of driving the free end of the snap cantilever to tilt up.

3. The circular connector according to claim 2, wherein the end of the snap cantilever without the snap groove is connected to the plastic housing through a connecting rib, and a ratio of a linear distance from an end of the pressing part far away from the connecting rib to the connecting rib, to a linear distance from the free end of the snap cantilever to the connecting rib is ⅓ to ⅔.

4. The circular connector according to claim 2, wherein there is a gap between the pressing part and an outer wall of the plug assembly.

5. The circular connector according to claim 1, wherein the plug snap protrusion extends radially outward from the plug assembly and tapers in width along its extending direction.

6. The circular connector according to claim 1, wherein:
the socket locking protrusion and the plug locking protrusion are spaced apart along the axial direction of the circular connector; and
when the plastic housing is rotated to a predetermined position, the free end of the locking cantilever is embedded between the socket locking protrusion and the plug locking protrusion.

7. The circular connector according to claim 1, wherein:
a limiting groove is provided on an outer wall of the plug assembly along a generatrix direction of the plug assembly,
a limiting rib is provided on an inner wall of the plastic housing and protrudes inward to mate with the limiting groove, and
when the plastic housing is rotated to a predetermined position, the limiting rib abuts against a side wall of the limiting groove.

8. The circular connector according to claim 7, further comprising a secondary lock body inserted in the limiting groove , wherein:
the secondary lock body comprises a baffle and at least one first cantilever fixed to the baffle, and a first protrusion is protrudingly provided on an end face of the first cantilever; and
a cantilever groove for being mated with the first cantilever is formed on the plastic housing along a circumferential direction, and when the plastic housing is rotated to a predetermined position, the secondary lock body is capable of being pushed to enable the first protrusion on the first cantilever to engage with the cantilever groove to realize secondary locking.

9. The circular connector according to claim 8, wherein:
the secondary lock body further comprises a second cantilever fixedly connected to the baffle, with a length longer than that of the first cantilever, and a second protrusion is protrudingly provided on a side of the second cantilever far away from the first cantilever;
a pre-mounting groove communicated with the limiting groove is provided on the outer wall of the plug assembly along the circumferential direction; and
when the secondary lock body is partially inserted into the limiting groove, the second protrusion engages with the pre-mounting groove, and when the secondary lock body is fully inserted into the limiting groove, the first protrusion on the first cantilever engages with the cantilever groove.

10. The circular connector according to claim 9, wherein the baffle, the first cantilever and the second cantilever are integrally injection-molded.

11. The circular connector according to claim 9, wherein an end of the plastic housing mated with the secondary lock body is recessed inward to form a lock body embedding groove for the baffle to be embedded in.

12. The circular connector according to claim 9, wherein a retractable third protrusion is further provided on the side of the second cantilever far away from the first cantilever, and when the secondary lock body is fully inserted into the limiting groove, the third protrusion engages with the pre-mounting groove.

13. The circular connector according to claim 12, wherein a retraction groove for the third protrusion to be embedded in is formed on the second cantilever, a return spring is provided between the third protrusion and the retraction groove, and when the third protrusion is pressed by an inner wall of the limiting groove, the third protrusion at least partially retracts into the retraction groove.

14. The circular connector according to claim 9, wherein:
a third cantilever is provided in the cantilever groove of the plastic housing, and has one end connected to the plastic housing and the other end extending in a direction opposite to a mounting direction along which the plastic housing is mounted into the plug assembly; and
a free end of the third cantilever is capable of engaging with a side wall of the pre-mounting groove after the plastic housing is mounted.
